(19) United States
(12) Patent Application Publication
(10) Pub. No.: US 2009/0164290 A1
(43) Pub. Date: Jun. 25, 2009

(54) SYSTEM AND METHOD FOR ACTIVITY SCHEDULING

(76) Inventors: Frank Haschick, Dresden (DE); Rene Pfeiffer, Dresden (DE)

Correspondence Address: KENYON & KENYON LLP, ONE BROADWAY, NEW YORK, NY, 10004, US

(21) Appl. No.: 11/962,089

(22) Filed: Dec. 20, 2007

(51) Int. Cl. G06Q 10/00; G06F 7/06; G06F 17/30

(52) U.S. Cl. 705/9; 707/104.1; 707/E17.005

(57) ABSTRACT

A system and method for a shift management system which is implemented over a computer network and may include graphical user interfaces that allow users, such as mangers, to define shifts, define activities for those shifts, and create personnel profiles for employees. The same or different managers may also assign shifts to employees and assign activities to those shifts.

### FIELD OF THE INVENTION

The present invention relates generally to the field of resource management and, more specifically, to managing shift and activity information for groups of personnel.

### BACKGROUND

Shift managers in a wide array of industries ranging from food services to automobile manufacturing run scheduling software for managing the schedules of employees. In some instances, resource scheduling is done in incremental steps. First, a manager, who may be located remotely from a job site, schedules their production resources, such as factories and equipment, for one or more shifts per day. For example, a day may include two eight-hour shifts with an eight-hour closed period, four six-hour shifts, or any other such division. A shift generally refers to the amount of time an employee will work and the location of where the employee will work. (e.g., in which organizational unit or in which location). The shift information usually contains a start time and an end time. This information may be captured by existing shift-management software, but the existing solutions have limited ability to associate shift information with additional types of information, such as activity information.

After assigning employees to various shifts through the software, a manager will then typically assign the employees to different activities within their shifts such as unpack, pack, ramp work, etc. For example, these assignments might be based on a shift time frame received from the headquarters as well as based on the particular employees available. Existing software solutions do not adequately capture this additional information. Managers now usually must take the shift information and export it to external software programs such as a spreadsheet before adding the additional information. After the shifts and activities are scheduled, the production manager must report the schedule information to headquarters on paper.

Accordingly, there exists in the art a need for scheduling software with an improved ability to add additional information and an improved ability to report such additional information.

### SUMMARY OF THE INVENTION

Embodiments of the present invention provide a system and method which may be implemented over a computer network and may include a shift management application that allows users, such as mangers, to associate activity information with shift information for employees. An embodiment according to the present invention may include the capabilities to allow a manager to control the shifts and activities available on both an organizational level as well as a personnel level. The system also may include a mechanism for outputting the information entered in various formats.

### BRIEF DESCRIPTION OF THE DRAWINGS

FIG. 1 is a block diagram showing a computer network that may be used according to the present invention.

FIG. 2 is a block diagram showing an example structure of a work station configured to the example network shown in FIG. 1.

FIG. 3 is an example of an output display containing shift information entered into a shift management application.

FIG. 4 is an example of a user interface for displaying shift information and assigning activity information.

FIG. 5 is an example of a user interface that may be used to enter shift information regarding a particular organizational unit.

FIG. 6 is an example of a user interface that may be used to enter information regarding particular employees.

FIG. 7 is an example of an attendance report that may be generated according to the present invention.

### DETAILED DESCRIPTION

A system embodying aspects of the present invention includes a shift planning application for managing the process of assigning employees within an organization to a particular shift. An aspect of the present invention includes allowing a group of managers to define shifts and activities as well as create personnel profiles, and based on the shift definitions, activity definitions, and personnel profiles, assign employees to particular shifts.

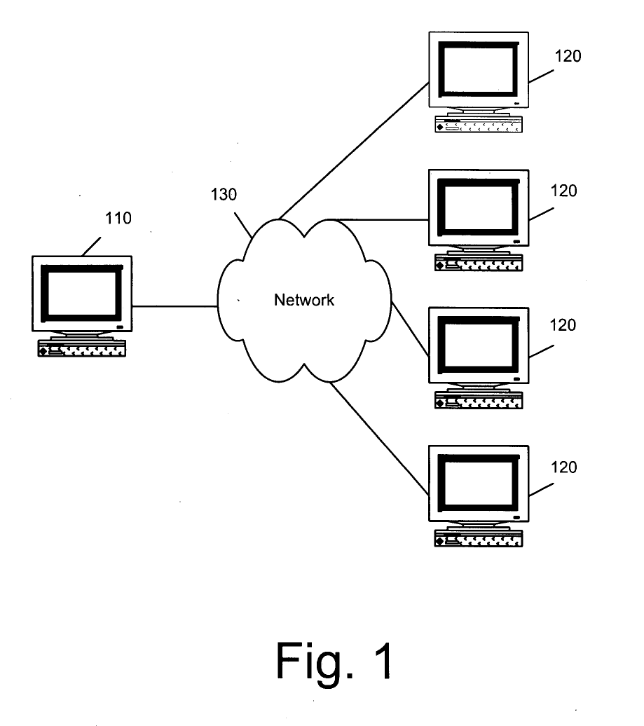

FIG. 1 illustrates the components of a possible system and basic computer and network architecture that may implement a shift planning application embodying aspects of the present invention. The shift management application system 100 includes a master terminal 110 and one or more user terminals 120 connected through a network 130. A first manager may control the shift management application from the master terminal 110, or alternatively, from one of the user terminals 120 or from any other device that may implement the method and is linked or connected in some manner to the system 100. The user terminals 120 may receive reports and instructions resulting from the shift management application, as well as any other additional information or instructions from the first manager or co-workers. One or more of the terminals 110, 120 may be personal computers, computer workstations, handheld personal digital assistants (“PDA”), or any other type of microprocessor-based device.

It is contemplated that access to different aspects of the shift management application might be restricted depending on a user's classification. For example, a second manager may have access to some but not all of the features that the first manager has access to while other employees might only have read access to features such as displaying their particular assigned shifts. Although while describing aspects of the present invention the application may make reference to a first or second manager and to employees, it is recognized that the present invention is not limited to any particular organizational structure.

The network 130 may be a local area network (LAN), wide area network (WAN), remote access network, an intranet, or the Internet, for example. Network links for the network 130 may include telephone lines, DSL, cable networks, T1 or T3 lines, wireless network connections, or any other arrangement that implements the transmission and reception of network signals. However, while FIG. 1 shows the terminals 110, 120 connected through a network 130, the terminals 110, 120 may be connected through other means, including directly hardwired or wirelessly connected. In addition, the terminals 110, 120 may be connected to other network devices not shown, such as wired or wireless routers and servers. The terminals 110, 120 may also be connected to one or more peripheral devices, such a local or network printer, mouse, display, storage drives, etc.

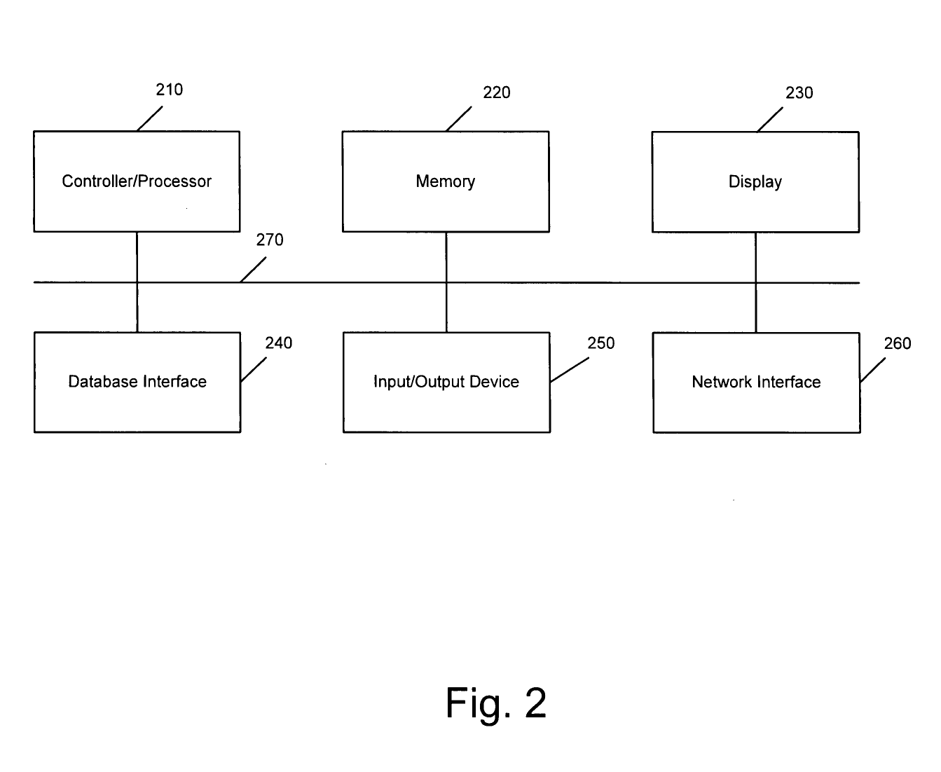

FIG. 2 illustrates a possible configuration of a master terminal 110 (the user terminal 120 may also have a similar configuration). The master terminal 110 may include a controller/processor 210, memory 220, display 230, database interface 240, input/output device interface 250, and network interface 260, connected through bus 270.

The controller/processor 210 may be any programmed processor available to one of skill in the art. In an embodiment, the decision shift management application may also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, and/or the like. In general, any device or devices capable of implementing the decision support method according to the present invention as described herein may be used to implement the decision support system functions of this invention.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The memory 220 may include volatile and nonvolatile data storage, including one or more electrical, magnetic or optical memories such as a RAM, cache, hard drive, CD-ROM drive, tape drive or removable storage disk.

The network interface 260 may be connected to a communication device, modem, network interface card, or any other device capable of transmitting and receiving signals over a network 130. The components of the terminals 110, 120 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The terminals 110, 120 may implement any operating system, such as Windows or UNIX, for example. Client and server software may be written in any programming language, such as ABAP, C, C++, Java or Visual Basic, for example.

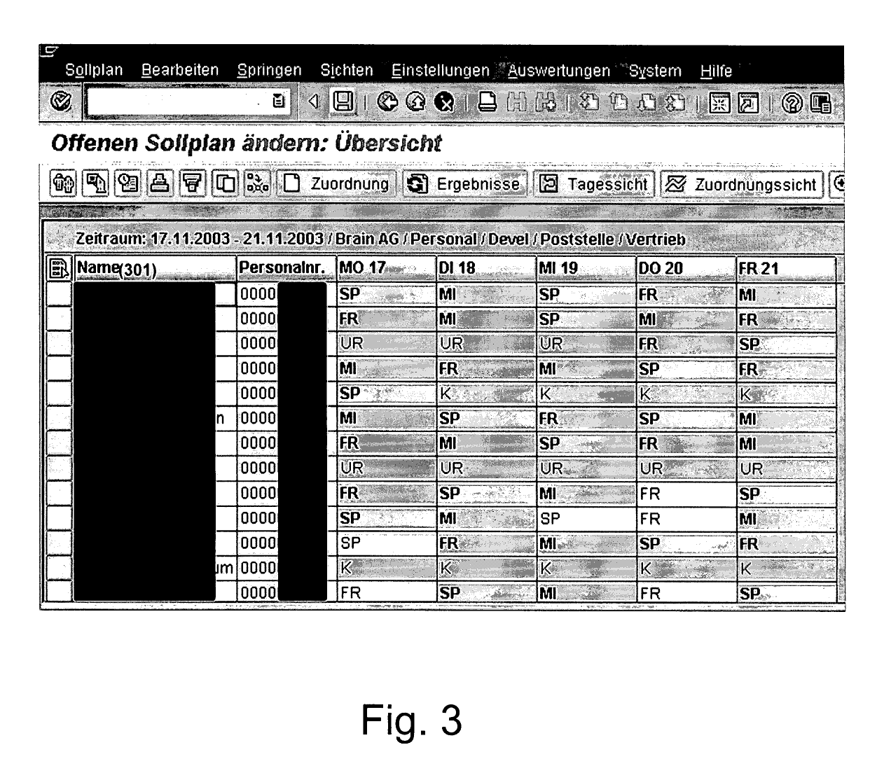

FIG. 3 shows an example of an output screen for a shift management application. The output screen can include a name column 301 as well as columns for different days of a week (see e.g. MO 17, DI 18, MI19, DO 20, and FR 21). The grids corresponding to a particular name and particular day can be filled in with a shift identifier (see e.g. SP, FR, UR, MI, and K). Each shift identifier can correspond to a particular time. For example, FR might equate to the early shift. The data entered to create the output of FIG. 3 might be entered by a first manager at a location remote from the employees he is assigning to shifts.

An aspect of the present invention includes allowing either the first or a second manger to access the information of FIG. 3 and enter additional information corresponding with the shift information. For example, a second manager may take the shifts provided by the first manager and add activity information identifying what task each employee will be performing during their particular shift. The second manager can access the shift information over a network and may be located remotely from the first manager.

The activities available for each employee can be controlled both on an organizational level as well as a personnel level. A shift management application can simultaneously manage multiple organizational units, with each organizational unit corresponding to a particular department, location, facility, or other grouping of individuals within a company. Each organizational unit can include different available shifts as well different available activities. For example, the activities for a certain organizational unit might include packing, unpacking, loading, and unloading. Certain activities, however, might not correspond to certain shifts. For example, there may be no unpacking on the Thursday late shift. An embodiment of the present invention includes enabling managers to associate particular activities with specific shifts so that when entering data, only available options are presented to the individuals assigning the shifts and the activities.

Within each organizational unit there can be multiple individuals. An embodiment of the present invention includes allowing managers to also control the available shifts and activities on a personnel level. Of the set of available shifts and activities associated with a particular organizational unit, only a subset of the shifts and activities might be associated with a particular employee. For example, a particular employee may only pack or unpack and not load or unload. The same employee may be available for a morning shift and an afternoon shift but not a later shift. An aspect of the present invention includes enabling managers to associate particular activities and shifts with particular employees so that when entering data, only available options are presented to the individuals assigning the shifts and the activities.

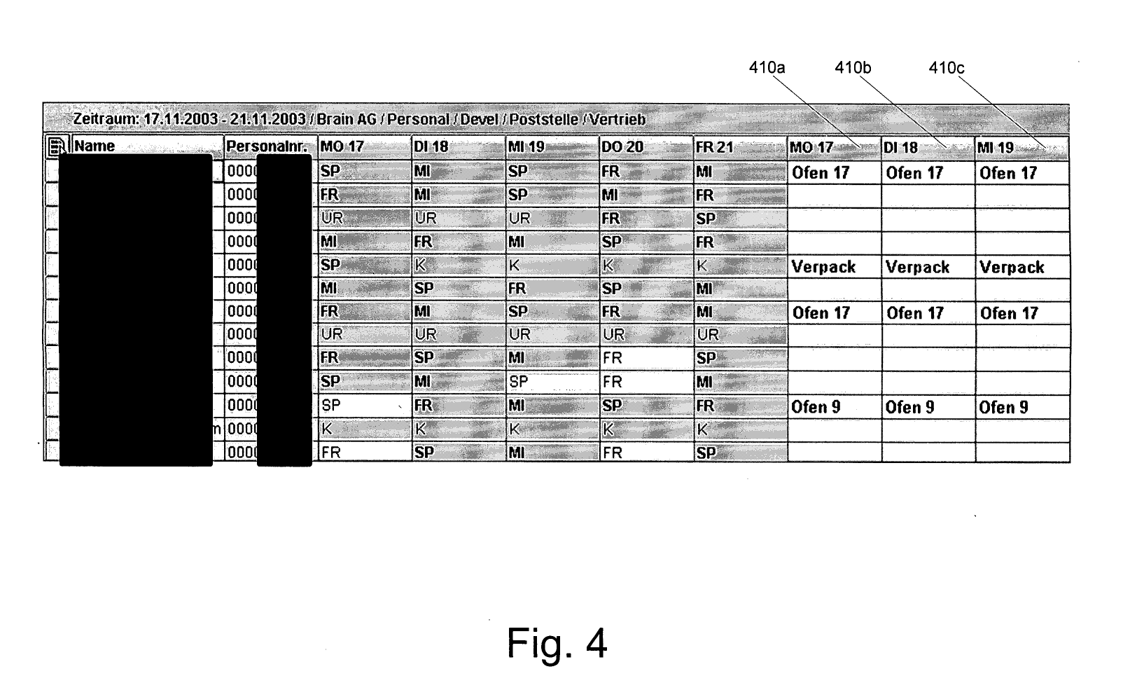

Another aspect of the present invention includes building upon the output shown in FIG. 3 by adding additional columns corresponding to additional information associated with a particular shift. FIG. 4 shows an input screen for a system embodying aspects of the present invention. The input screen includes the same output information (such as name, day, and shift) as FIG. 3, but with additional columns 410a,b,c for inputting additional information, such as activity information (see, e.g., Verpack, Ofen 9, and Ofen 17). It will be readily apparent to one of skill in the art that the format of FIGS. 3 and 4 are non-limiting examples, and many other formats can be used.

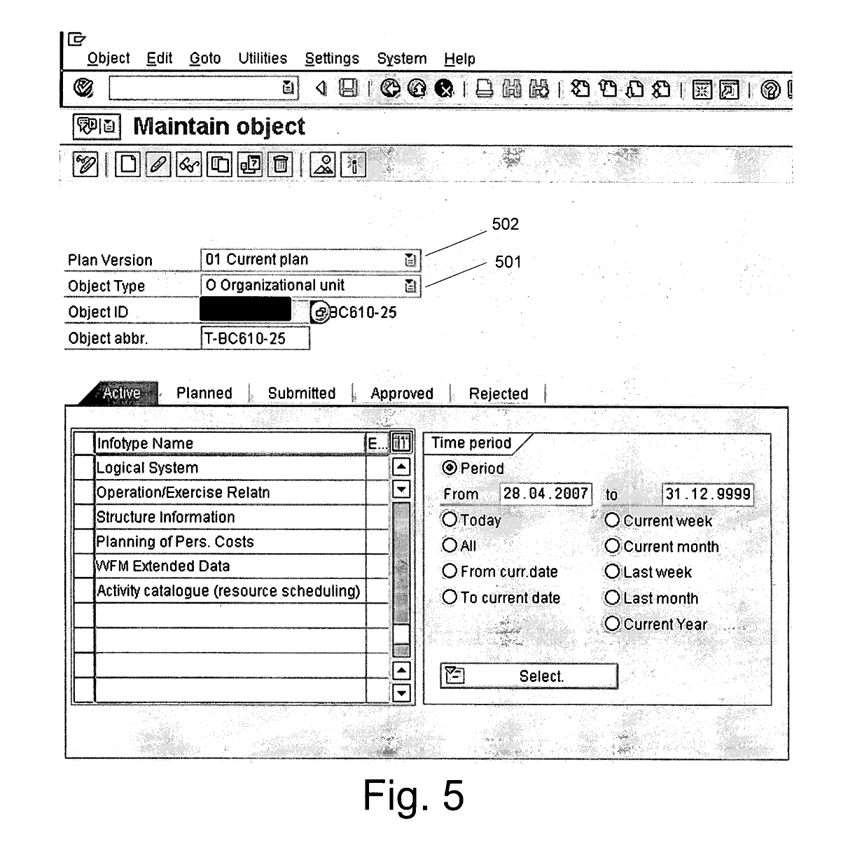

FIG. 5 shows an example of an interface for a system embodying aspects of the present invention. A user, such as a manager, can define a global shift and activity catalogue for a particular organizational unit (see e.g., 501). A user can also create a plan version (see e.g., 502) for defining different variants of the organizational structure and its related objects. The information entered by a first manager in FIG. 5 can be used to limit or check the information entered in FIG. 4. For example, if using the input screen of FIG. 4, a shift manager tries to assign an activity not in the activity catalog, then the screen of FIG. 4 might produce an error message. Alternatively, the input screen of FIG. 4 might contain a drop down menu configured to only list available activities that have been entered into the activity catalog through the entry screen in FIG. 5.

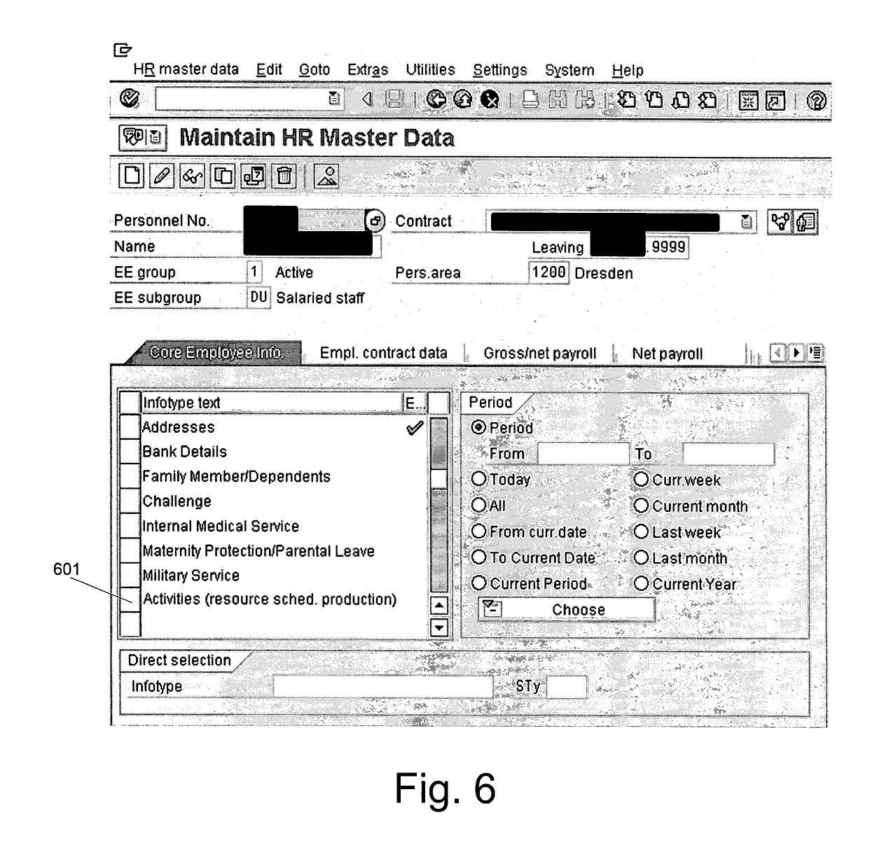

Another embodiment of the present invention includes allowing each employee to have a unique profile. FIG. 6 shows an example of an interface that can be used by a manager to both view information and enter information about a particular employee. A profile of an employee can be created or edited, and one section of that profile might include activity information 601. The activity information 601 might include a list of activities for which a particular employee is eligible to be assigned. The information entered in FIG. 6 can be used when executing the shift management application. For example, using the screen of FIG. 6, a first manager might be able to make an employee eligible for morning and afternoon shifts but not for late shifts. In an embodiment, when a second manager tries to assign that employee to a particular shift, the manager will be prevented from assigning that employee to a late shift.

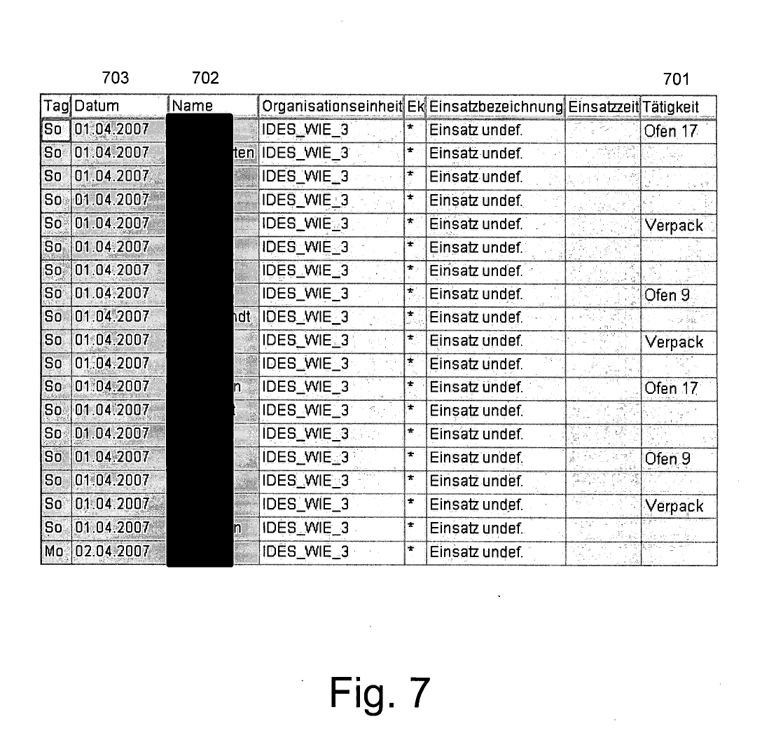

FIG. 7 is an example of a report that may be generated using the present invention. The column “Tatigkeit” 701, for example, shows the activity information assigned by a manager through FIG. 4. That activity information can correspond to a name 702 and date 703. The various activities can be defined by a different manager through the interface of FIG. 5.

The foregoing description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, some or all of the features of the different embodiments discussed above may be combined together and/or without each other. Therefore, the present invention is not intended to be limited to the embodiments described herein but is to be accorded the widest scope defined only by the claims below and equivalents thereof. Further, embodiments of the present invention include a computer-readable medium storing instructions adapted to execute the system and/or methods of the present invention.

What is claimed is:

1. A shift-management system comprising:
a shift definition module to create shifts;
an activity catalog module to define activities associated with the shifts;
a personnel profile module to create profiles for employees, the profiles to include information related to the shifts and the activities the employees are eligible to be assigned;
a shift assignment module to assign shifts to the employees, wherein shifts eligible to be assigned are to be determined by data entered into the shift definition module, the activity catalog module, and the personnel profile module; and,
an activity assignment module to assign activities to the employees, wherein activities eligible to be assigned are to be determined by data entered into the shift definition module, the activity catalog module, the personnel profile module, and the shift assignment module.

2. The shift-management system of claim 1, wherein graphical user interfaces for entering data into the shift definition module, activity catalog module, personnel profile module, shift assignment module, and activity assignment module are accessible over a network connection.

3. The shift-management system of claim 1, wherein access to the shift definition module, activity catalog module, personnel profile module, and shift assignment module is restricted based on a user's classification.

4. The shift-management system of claim 1, wherein access to the activity assignment module is granted to users who do not have access to the shift definition module, activity catalog module, personnel profile module, or shift assignment module.

5. The shift-management system of claim 1, wherein users can access the shift assignment module through a graphical user interface, the graphical user interface configured to not display activities not eligible to be assigned.

6. The shift-management system of claim 1, further comprising a summary output module configured to produce a summary of information entered into the shift definition module, the activity catalog module, the personnel profile module, the shift assignment module, and the activity assignment module.

7. The shift-management system of claim 1, wherein the activity assignment module is configured to accept activity information and associate the activity with a specific employee and time.

8. The shift-management system of claim 1, wherein the personnel profile module is configured to allow a user to input an activity or a shift for which an employee is eligible.

9. The shift-management system of claim 1, wherein the shift definition module is configured to allow a user to input start times and end times for the shifts.

10. A computer program product tangibly embodied in a machine-readable storage device, the product comprising instructions operable to cause a data processing apparatus to:
generating a shift definition graphical user interface (GUI) for storing shift information;
generating an activity information GUI for storing activity information associated with the shifts;
generating a personnel profile GUI for storing profiles of employees, the profiles to include information related to shifts and activities the employees are eligible to be assigned;
generating a shift assignment GUI for assigning shifts to the employees, wherein shifts eligible to be assigned are to be determined by the shift information, the activity information, and the profiles;
generating an activity assignment GUI, wherein activities displayed are to be determined by the shift information, the activity information, the profiles, and shifts assigned to employees.

11. The computer program product of claim 10, wherein the shift definition GUI, activity information GUI, personnel profile GUI, shift assignment GUI, and activity assignment GUI are accessible over a network connection.

12. The computer program product of claim 10, wherein access to the shift definition GUI, activity information GUI, personnel profile GUI, shift assignment GUI, and activity assignment GUI is restricted based on a user's classification.

13. The computer program product of claim 10, wherein access to the activity assignment GUI is granted to users who do not have access to the shift definition GUI, activity catalog GUI, personnel profile GUI, or shift assignment GUI.

14. The computer program product of claim 10, wherein users can access the shift assignment GUI is configured to not display activities not eligible to be assigned.

15. The computer program product of claim 10, further comprising:
outputting a summary of information entered into the shift definition GUI, the activity assignment GUI, the personnel profile GUI, the shift assignment GUI, and the activity assignment GUI.

16. The computer program product of claim 10, wherein the activity assignment GUI is configured to receive activity information from a user and associate the activity with a specific employee and time.

17. The computer program product of claim 10, wherein the personnel profile GUI is configured to receive from a user an activity or a shift for which an employee is eligible.

18. The computer program product of claim 10, the shift definition GUI is configured to allow a user to input start times and end times for the shifts.
